(19) United States
(12) Patent Application Publication
(10) Pub. No.: US 2015/0124879 A1
(43) Pub. Date: May 7, 2015

(54) INTRA PREDICTION DEVICE FOR IMAGE

(71) Applicant: Foundation of Soongsil University-Industry Cooperation, Seoul (KR)

(72) Inventors: Seung-Soo Lee, Seoul (KR); Jong-Sik Park, Goyang (KR); Woo-Jin Nam, Seoul (KR); Seung-Mok Han, Seoul (KR); Kie-Yong Park, Seoul (KR); Jong-Bae Lee, Seoul (KR)

(21) Appl. No.: 14/584,937

(22) Filed: Dec. 29, 2014

Related U.S. Application Data
(63) Continuation of application No. PCT/KR2012/008961, filed on Oct. 29, 2012.

(30) Foreign Application Priority Data
Jun. 28, 2012 (KR) 10-2012-0070035

(51) Int. Cl. H04N 19/593

(52) U.S. Cl. CPC H04N 19/593
USPC 375/240.12

(57) ABSTRACT

A device for performing intra prediction for an image is disclosed. The disclosed intra prediction device includes: a subtractor configured to perform a subtraction operation on a first reference value and a second reference value of a prediction target pixel; a multiplier configured to perform a multiplication operation on a parameter set for each angular mode and an output value of the subtractor; and an adder configured to perform an addition operation on a product of the first reference value multiplied by a predetermined constant and an output value of the multiplier, where an output value of the adder is a resultant value of intra prediction for the image according to an angular mode.

### CROSS-REFERENCE TO RELATED APPLICATIONS

This application is a continuation of International Application No. PCT/KR2012/008961 filed on Oct. 29, 2012, which claims priority to Korean Application No. 10-2012-0070035 filed on Jun. 28, 2012. The applications are incorporated herein by reference.

### TECHNICAL FIELD

Embodiments of the present invention relate to an intra prediction device, more particularly to a device that performs intra prediction for an image according to an angular mode and performs intra prediction for an image according to a planar mode.

### BACKGROUND ART

With recent advances in digital video compression technology, many types of images are being provided to users in digitized form, and users are demanding images such as Full-HD 3D images, UHD (ultra high definition) images, etc., which provide higher picture quality and resolution compared to previous types of images.

To satisfy these user demands, the MPEG (Moving Picture Experts Group) and the VCEG (Video Coding Experts Group) formed an organization called JCT-VC (Joint Collaborative Team on Video Coding) and are conducting studies on the HEVC (High Efficiency Video Coding) standard, which allows a high compression ratio of more than twice that provided by the H.264/AVC standard.

A video codec adhering to the H.264/AVC standard may perform intra prediction by using blocks of 4×4, 8×8, and 16×16 sizes. Also, a video codec adhering to the H.264/AVC standard may perform intra prediction for an image according to nine modes for block sizes of 4×4 and 8×8 (i.e. eight directional modes and one DC mode) and according to four modes for block sizes of 16×16 (i.e. three directional modes and one DC mode).

In contrast, a video codec adhering to the HEVC standard may perform intra prediction for an image according to a maximum of 35 modes as illustrated in FIG. 1 (i.e. DC modes for the vertical direction and the horizontal direction, 31 angular modes having directionality, and a planar mode), in order to provide a high compression ratio.

However, the HEVC standard uses a complex encoding/decoding algorithm to implement a high compression ratio, as a result of which the amount of computation during encoding/decoding is increased by two to four times compared to conventional techniques. This in turn may increase the size of the device (hardware) needed for the encoding/decoding.

### SUMMARY

An aspect of the present invention is to propose an intra prediction device that allows the encoding/decoding of an image according to a complex algorithm while reducing the size of the hardware.

Other objectives of the present invention can be derived by those of ordinary skill in the art from the embodiments described below.

One embodiment of the present invention provides a device for the intra prediction of an image that includes: a subtractor configured to perform a subtraction operation on a first reference value and a second reference value of a prediction target pixel; a multiplier configured to perform a multiplication operation on a parameter set for each angular mode and an output value of the subtractor; and an adder configured to perform an addition operation on a product of the first reference value multiplied by a predetermined constant and an output value of the multiplier, where an output value of the adder is a resultant value of intra prediction for the image according to an angular mode.

Another embodiment of the present invention provides a device for the intra prediction of an image that includes: a subtractor configured to perform a subtraction operation on a first reference value and a second reference value of a prediction target pixel; a multiplier configured to perform a multiplication operation on a parameter associated with a position of the prediction target within an intra prediction block and an output value of the subtractor; a first adder configured to perform an addition operation on a product of the first reference value multiplied by a predetermined constant and an output value of the multiplier; and a second adder configured to perform an addition operation on an output value of the first adder at a first timepoint and an output value of the first adder at a second timepoint, where an output value of the second adder is a resultant value of intra prediction for the image according to a planar mode.

Still another embodiment of the present invention provides a device the intra prediction of an image that includes: a subtractor configured to perform a subtraction operation on a first reference value and a second reference value of a prediction target pixel; a multiplier configured to perform a multiplication operation on a predetermined parameter and an output value of the subtractor; a first adder configured to perform an addition operation on a product of the first reference value multiplied by a predetermined constant and an output value of the multiplier; and a second adder configured to perform an addition operation on an output value of the first adder at a first timepoint and an output value of the first adder at a second timepoint, where an output value of the second adder is a resultant value of intra prediction for the image according to a planar mode, and an output value of the first adder at a third timepoint is a resultant value of intra prediction for the image according to an angular mode.

An intra prediction device according to an embodiment of the present invention can provide the advantage of enabling the encoding/decoding of an image according to a complex algorithm while maintaining a relatively small size.

Also, an intra prediction device according to an embodiment of the present invention can provide the advantage of allowing the intra prediction of an image according to an angular mode and a planar mode using a single set of hardware.

### BRIEF DESCRIPTION OF DRAWINGS

FIG. 1 illustrates the concept of prediction modes under the HEVC standard.

FIG. 2 and FIG. 3 illustrate the concept of the intra prediction of an image according to a planar mode and according to an angular mode, as proposed by the HEVC standard.

FIG. 4 illustrates an embodiment of a device for the intra prediction of an image according to a planar mode.

FIG. 5 illustrates another embodiment of a device for the intra prediction of an image according to a planar mode.

FIG. 6 illustrates an embodiment of a device for the intra prediction of an image according to an angular mode.

FIG. 7 illustrates an embodiment of a device for the intra prediction of an image according to a planar mode and an angular mode.

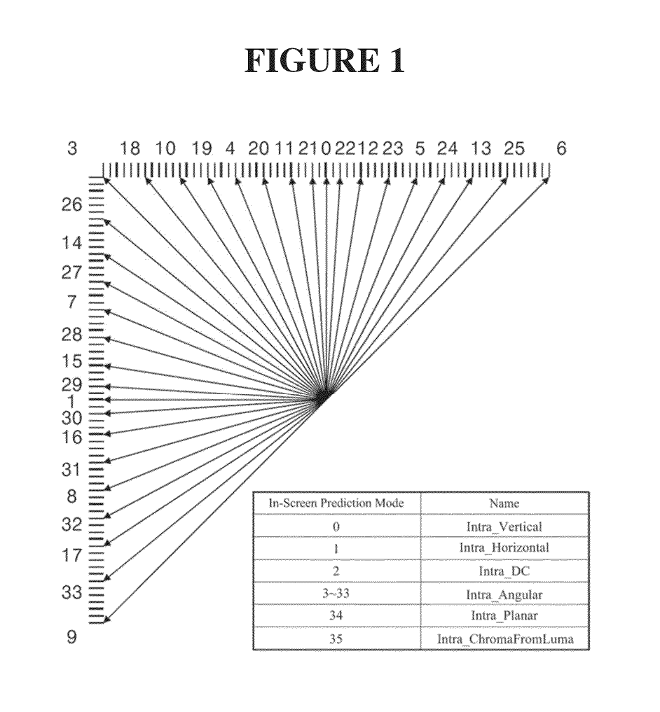

### DETAILED DESCRIPTION

As the present invention allows for various changes and numerous embodiments, particular embodiments will be illustrated in the drawings and described in detail in the written description. However, this is not intended to limit the present invention to particular modes of practice, and it is to be appreciated that all changes, equivalents, and substitutes that do not depart from the spirit and technical scope of the present invention are encompassed in the present invention. In describing the drawings, like reference numerals are used for like components.

Certain embodiments of the invention are described below in more detail with reference to the accompanying drawings.

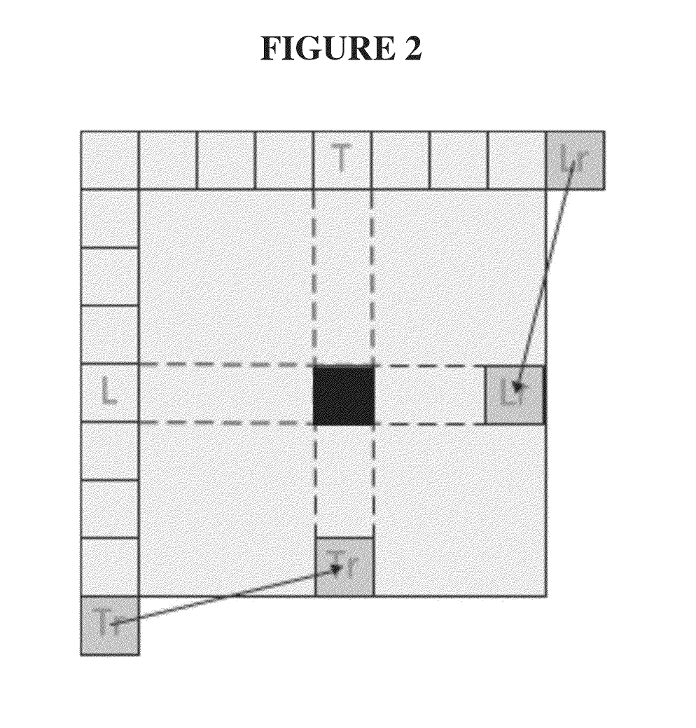

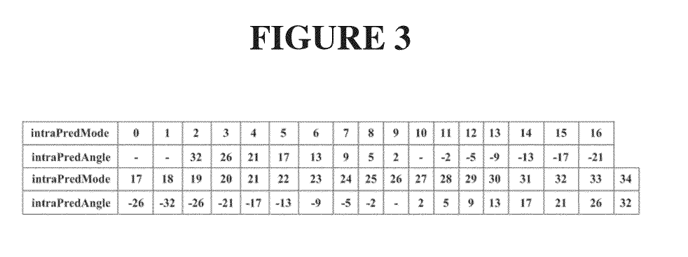

FIG. 2 and FIG. 3 illustrate the concept of the intra prediction of an image according to a planar mode (FIG. 2) and according to an angular mode (FIG. 3), as proposed by the HEVC (High Efficiency Video Coding) standard.

First, in the case of a planar mode, performing the intra prediction for a prediction target pixel may require four reference values related to the prediction target pixel (i.e. the pixel values of four reference pixels related to the prediction target pixel), a first parameter associated with a vertical-axis position of the prediction target pixel within the intra prediction block, and a second parameter associated with a horizontal-axis position of the prediction target pixel within the intra prediction block.

Here, the four reference pixels for the prediction target pixel can be set as shown in FIG. 2 (in which the four reference pixels are T, Tr, L, and Lr, and the prediction target pixel is shown in black). Also, if the position of the prediction target pixel is represented as (x, y), then the first parameter may be represented as “y+1”, and the second parameter may be represented as “x+1”. In the descriptions that follow, L is referred to as the “1-1 reference value”, Lr is referred to as the “2-1 reference value”, T is referred to as the “1-2 reference value”, and Tr is referred to as the “2-2 reference value”.

Under the conditions described above, the resultant value of intra prediction for an image (the target pixel) according to a planar mode may be expressed as Equation 1 shown below.

outputₚ=(nS−(x+1))×L+(x+1)×Lr+(nS−(y+1))×T+(y+1)×Tr [Equation 1]

Here, outputₚ represents the resultant value of the intra prediction for the image according to a planar mode, and nS(=2^{N}, where N is a predetermined integer) is a predetermined constant that represents the number of pixels corresponding to the horizontal/vertical length of the intra prediction block.

Next, in the case of an angular mode, performing the intra prediction for a prediction target pixel may require two reference values related to the prediction target pixel and a third parameter set for each angular mode.

Here, the angle for each of the angular modes may be set as in the table shown in FIG. 3, and the two reference values and third parameter may be expressed as Equation 2 shown below.

first reference value=refMain[x+ildx+1]

second reference value=refMain[x+ildx+2]

Delta=((y+1)×intraPredAngle)&&31

where

ildx=((y+1)×intraPredAngle)>>5 [Equation 2]

Here, Delta represents the third parameter, intraPredAngle represents the angle for each angular mode as shown in FIG. 3, && represents the “and” operator, and >> represents the “shift” operator.

Under the conditions described above, the resultant value of intra prediction for an image (the target pixel) according to an angular mode may be expressed as Equation 3 shown below.

outputₐ=(32−Delta)×refMain1+Delta×refMain2 [Equation 3]

Here, outputₐ represents the resultant value of intra prediction for the image according to an angular mode, 32 (=2^{N}, where N=5) is a predetermined constant, refMain1 represents the first reference value, and refMain2 represents the second reference value.

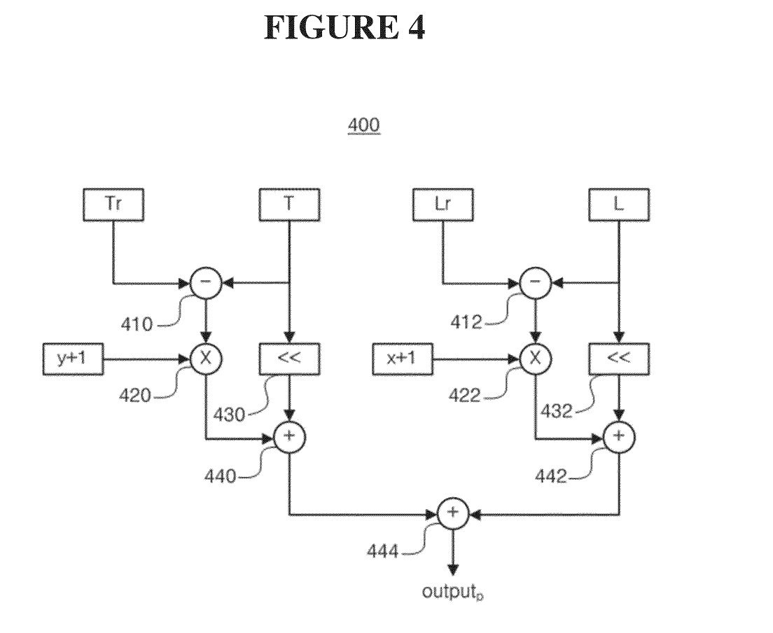

Certain embodiments of the intra prediction device for performing the intra prediction of an image according to aspects of the present invention are described below in more detail with reference to the fundamentals of the HEVC standard described above and to FIG. 4 through FIG. 7.

FIG. 4 illustrates an embodiment of a device for the intra prediction of an image according to a planar mode (hereinafter referred to as a “planar-mode intra prediction device”).

Referring to FIG. 4, a planar-mode intra prediction device 400 according to an embodiment of the present invention may include two subtractors 410, 412, two multipliers 420, 422, two shifters 430, 432, and three adders 440, 442, 444. The function of each component is described below in more detail.

The first subtractor 410 may perform a subtraction operation on the 1-1 reference value (T) and the 2-1 reference value (Tr) of the prediction target pixel. More specifically, the first subtractor 410 may perform the operation of subtracting the 1-1 reference value (T) from the 2-1 reference value (Tr).

The first multiplier 420 may perform a multiplication operation on the first parameter (y+1), which is associated with the vertical-axis position of the prediction target pixel within the intra prediction block, and the output value of the first subtractor 410.

The first shifter 430 may shift the 1-1 reference value (T) by N bits. Since N represents an exponent value, by which the predetermined constant referred to in Equation 1 above is expressed as an N-th power of 2, the first shifter 430 may essentially perform a multiplication operation on the 1-1 reference value (T) and a predetermined first constant, where the first constant can correspond to the number of pixels corresponding to the horizontal/vertical length of the intra prediction block.

The first adder 440 may perform an addition operation on a product of the 1-1 reference value (T) multiplied by the first constant and the output value of the first multiplier 420.

Here, the “(nS−(y+1))×T+(y+1)×Tr” part of Equation 1 can be reduced to “(y+1)×(Tr−T)+nS×T”, and by this operation, the first adder 440 may output the value of “(y+1)×(Tr−T)+nS×T”.

Next, the second subtractor 412 may perform a subtraction operation on the 1-2 reference value (L) and the 2-2 reference value (Lr). In this case also, the second subtractor 412 may perform the operation of subtracting the 1-2 reference value (L) from the 2-2 reference value (Lr).

The second multiplier 422 may perform a multiplication operation on the second parameter (x+1), which is associated with the horizontal-axis position of the prediction target pixel within the intra prediction block, and the output value of the second subtractor 412.

The second shifter 432 may shift the 1-2 reference value (L) by N bits. Here also, N represents an exponent value, by which the predetermined constant referred to in Equation 1 above is expressed as an N-th power of 2, so that the second shifter 432 may essentially perform a multiplication operation on the 1-2 reference value (L) and a predetermined second constant, where the second constant can correspond to the number of pixels corresponding to the horizontal/vertical length of the intra prediction block.

The second adder 442 may perform an addition operation on a product of the 1-2 reference value (L) multiplied by the second constant and the output value of the second multiplier 422.

Here, the “(nS−(x+1))×L+(x+1)×Lr” part of Equation 1 can be reduced to “(x+1)×(Lr−L)+nS×L”, and by this operation, the second adder 442 may output the value of “(x+1)×(Lr−L)+nS×L”.

Lastly, the third adder 444 may perform an addition operation on the output value of the first adder 440 and the output value of the second adder 442. Accordingly, the third adder 444 may output the same value as Equation 1. That is, the output value of the third adder 444 may be the resultant value of the intra prediction for the image according to a planar mode.

Looking at Equation 1 above, the intra prediction of an image according to the planar mode may require two subtraction operations, five addition operations, and four multiplication operations, but according to an embodiment of the present invention, these operations may be performed using the two subtractors 410, 412, three adders 440, 442, 444, two multipliers 420, 422, and two shifters 430, 432. In particular, whereas a multiplier may generally occupy a large size within the prediction device, the planar-mode intra prediction device 400 according to an embodiment of the present invention may use only two multipliers 420, 422, so that the size of the hardware can be reduced compared to conventional devices.

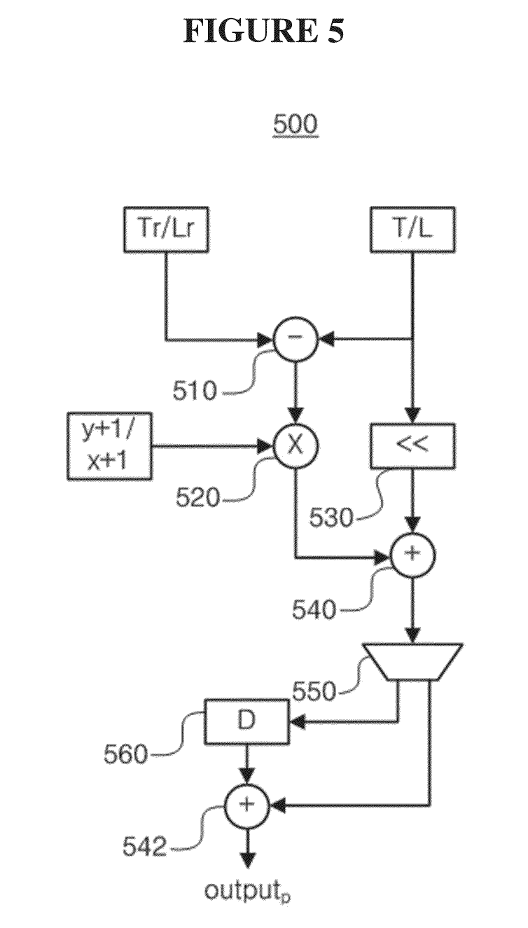

Referring to FIG. 4, the planar-mode intra prediction device 400 according to an embodiment of the present invention may exhibit left-right symmetry with respect to the third adder 444. Thus, by taking advantage of this feature of a symmetrical structure, the number of operators used can be reduced, making it possible to further reduce the size of the hardware. Below, a planar-mode intra prediction device according to another embodiment of the present invention is described in more detail, with reference to FIG. 5, where the planar-mode intra prediction device utilizes this symmetrical structure.

FIG. 5 illustrates another embodiment of a planar-mode intra prediction device, where the device illustrated in FIG. 5 is modified from the planar-mode intra prediction device described above with reference to FIG. 4 to take advantage of the symmetry in the structure.

More specifically, referring to FIG. 5, the planar-mode intra prediction device 500 according to another embodiment of the present invention may include a subtractor 510, a multiplier 520, a shifter 530, two adders 540, 542, a selector 550, and a storer 560. The function of each component is described below in more detail.

The subtractor 510 may perform a subtraction operation on the first reference value and the second reference value of the prediction target pixel. More specifically, the subtractor 510 may output the value of subtracting the first reference value from the second reference value. Here, the first reference value and the second reference value can be the 1-1 reference value (T) and the 2-1 reference value (Tr), or the 1-2 reference value (L) and the 2-2 reference value (Lr).

The multiplier 520 may perform a multiplication operation on a parameter associated with a position of the prediction target pixel within the intra prediction block and the output value of the subtractor 510. Here, the parameter can be the first parameter (y+1), associated with the vertical-axis position of the prediction target pixel within the intra prediction block, or the second parameter (x+1), associated with the horizontal-axis position of the prediction target pixel within the intra prediction block.

More specifically, in cases where the subtractor 510 performs the subtraction operation on the 1-1 reference value (T) and the 2-1 reference value (Tr), the multiplier 520 may perform a multiplication operation on the first parameter (y+1) and the output value of the subtractor 510. Also, in cases where the subtractor 510 performs the subtraction operation on the 1-2 reference value (L) and the 2-2 reference value (Lr), the multiplier 520 may perform a multiplication operation on the second parameter (x+1) and the output value of the subtractor 510.

The shifter 530 may shift the first reference value (T or L) by N bits. As described above, this essentially corresponds to a multiplication operation on the first reference value (T or L) and a predetermined constant (sN) expressed as 2^{N}.

The first adder 540 may perform an addition operation on a product of the first reference value (T or L) multiplied by a predetermined constant (sN) and the output value of the multiplier 520, and the output value of the first adder 540 may be inputted to the selector 550. Then, the selector 550 may output the output value of the first adder 540 through either one of a first path and a second path. For instance, the selector 550 can be a demultiplexer.

Here, the first path may be connected with the storer 560, and the second path may be connected with the second adder 542. Also, the second adder 542 may be connected with the output end of the storer 560, and the output value of the second adder 542 may correspond to the resultant value of the intra prediction for the image according to the planar mode.

The planar-mode intra prediction device 500 having the composition above may perform the operations for the intra prediction of an image according to the planar mode differently for a first time segment and a second time segment. That is, the planar-mode intra prediction device 500 may perform the intra prediction operations for the 1-1 reference value (T) and the 2-1 reference value (Tr) in the first time segment and perform the intra prediction operations for the 1-2 reference value (L) and the 2-2 reference value (Lr) in the second time segment.

More specifically, in the first time segment that includes a first timepoint, the subtractor 510 may perform the subtraction operation for the 1-1 reference value (T) and the 2-1 reference value (Tr), the multiplier 520 may perform the multiplication operation for the output value of the subtractor 510 and the first parameter, and the first adder 540 may perform an addition operation on the product of the 1-1 reference value multiplied by a predetermined constant (sN) and the output value of the multiplier 520 to provide an output at the first timepoint, where the output value of the first adder 540 outputted at the first timepoint may pass through the first path to be stored in the storer 560. Accordingly, the value of “(y+1)×(Tr−T)+nS×T” may be stored in the storer 560.

Continuing with the description, in the second time segment that includes a second timepoint, the subtractor 510 may perform the subtraction operation for the 1-2 reference value (L) and the 2-2 reference value (Lr), the multiplier 520 may perform the multiplication operation for the output value of the subtractor 510 and the second parameter, the first adder 540 may perform an addition operation on the product of the 1-2 reference value (L) multiplied by a predetermined constant (sN) and the output value of the multiplier 520 to provide an output at the second timepoint, where the output value of the first adder 540 outputted at the second timepoint may pass through the second path to be transferred to the second adder 542. Accordingly, the value of “(x+1)×(Lr−L)+nS×L” may be transferred to the second adder 542.

Afterwards, the second adder 542 may perform an addition operation on the output value of the first adder 540 that was outputted at the first timepoint and stored in the storer 560 and the output value of the first adder 540 that was outputted at the second timepoint through the second path. Accordingly, the resultant value of the intra prediction for the image according to the planar mode as expressed by Equation 1 above may be outputted at the second adder 542.

According to another embodiment of the present invention, the first time segment can be a time segment that is before the second time segment. In other words, the planar-mode intra prediction device 500 may perform the operations of planar-mode intra prediction for the 1-2 reference value (L) and the 2-2 reference value (Lr) first, and perform the operations of planar-mode intra prediction for the 1-1 reference value (T) and the 2-1 reference value (Tr) later.

Thus, the planar-mode intra prediction device 500 based on this embodiment can perform the same operations as the planar-mode intra prediction device 400 illustrated in FIG. 4 but with one less subtractor, multiplier, adder, and shifter. This makes it possible to further reduce the size of the hardware.

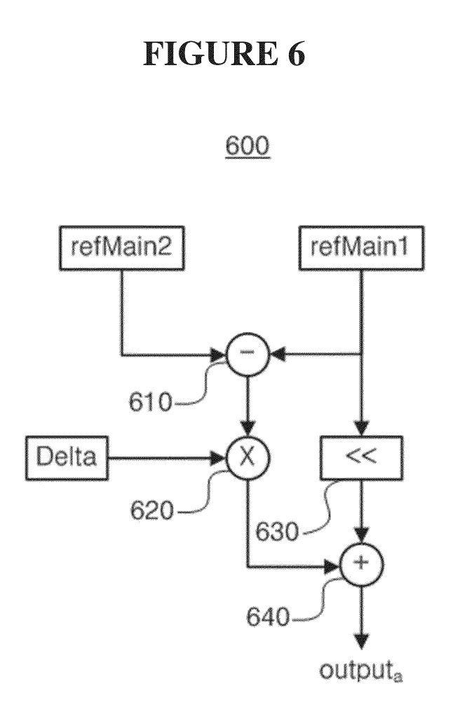

FIG. 6 illustrates an embodiment of a device for the intra prediction of an image according to an angular mode (hereinafter referred to as an “angular-mode intra prediction device”).

Referring to FIG. 6, an angular-mode intra prediction device 600 according to an embodiment of the present invention may include a subtractor 610, a multiplier 620, a shifter 630, and an adder 640. The function of each component is described below in more detail.

The subtractor 610 may perform a subtraction operation on the first reference value (refMain1) and the second reference value (refMain2). More specifically, the subtractor 610 may output the value of subtracting the first reference value (refMain1) from the second reference value (refMain2).

The multiplier 620 may perform a multiplication operation on the third parameter, which may be set according to each angular mode, and the output value of the subtractor 610. Here, the third parameter may be the parameter described above with reference to Equation 2.

The shifter 630 may shift the first reference value (refMain1) by N bits. This essentially corresponds to a multiplication operation on the first reference value (refMain1) and a predetermined constant expressed as 2^{N}. Here, the predetermined constant can be 32 (=2^{N}, N=5), and the shifter 630 can shift the first reference value (refMain1) by 5 bits.

The adder 640 may perform an addition operation on a product of the first reference value (refMain1) multiplied by a predetermined constant and the output value of the multiplier 620.

Accordingly, the value of “Delta×(refMain2−refMain1)+32×refMain1” may be outputted at the adder 640, and this corresponds to the resultant value of the intra prediction for an image according to an angular mode described above with reference to Equation 3.

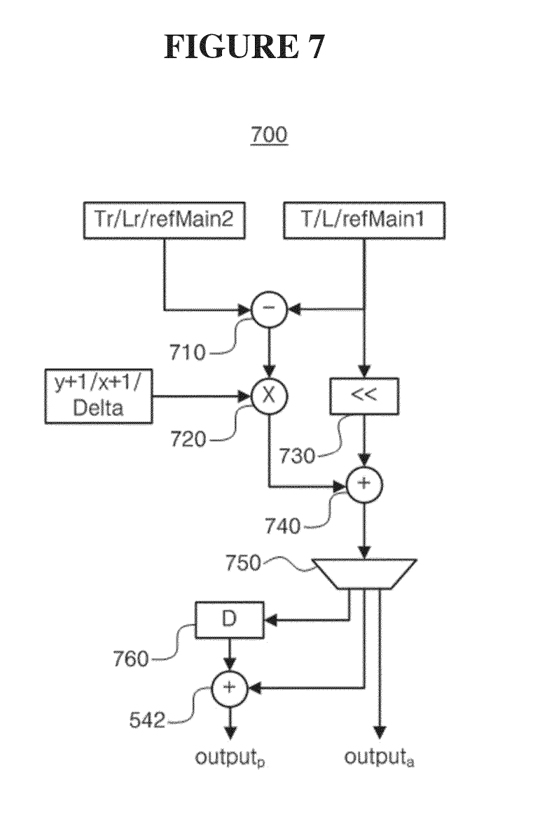

There are certain similarities between the planar-mode intra prediction device 500 illustrated in FIG. 5 and the angular-mode intra prediction device 600 illustrated in FIG. 6. Therefore, by utilizing these similarities in structure, it is possible to implement an intra prediction device that can perform both planar-mode intra prediction and angular-mode intra prediction. Below, a description is provided, with reference to FIG. 7, on a device for intra prediction of an image that can perform planar-mode intra prediction as well as angular-mode intra prediction.

FIG. 7 illustrates an embodiment of a device for the intra prediction of an image according to a planar mode and an angular mode (hereinafter referred to as a “planar/angular-mode intra prediction device”).

Referring to FIG. 7, the planar/angular-mode intra prediction device 700 according to an embodiment of the present invention may include a subtractor 710, a multiplier 720, a shifter 730, two adders 740, 742, a selector 750, and a storer 760. The function of each component is described below in more detail.

The subtractor 710 may perform a subtraction operation on the first reference value and second reference value of the prediction target pixel. More specifically, the subtractor 710 may output the value of subtracting the first reference value from the second reference value. Here, when the planar-mode intra prediction is performed, the first reference value and second reference value can be the 1-1 reference value (T) and 2-1 reference value (Tr) or the 1-2 reference value (L) and 2-2 reference value (Lr). Also, when the angular-mode intra prediction is performed, the first reference value can be refMain1, and the second reference value can be refMain2.

The multiplier 720 may perform a multiplication operation on a predetermined parameter and the output value of the subtractor 710. Here, when the planar-mode intra prediction is performed, the predetermined parameter can be the first parameter (y+1), which is associated with the vertical-axis position of the prediction target pixel within the intra prediction block, or the second parameter (x+1), which is associated with the horizontal-axis position of the prediction target pixel within the intra prediction block. Also, when the angular-mode intra prediction is performed, the predetermined parameter can be the third parameter set for each angular mode.

More specifically, in cases where the subtractor 710 performs the subtraction operation on the 1-1 reference value (T) and the 2-1 reference value (Tr), the multiplier 720 may perform a multiplication operation on the first parameter (y+1) and the output value of the subtractor 710. Also, in cases where the subtractor 710 performs the subtraction operation on the 1-2 reference value (L) and the 2-2 reference value (Lr), the multiplier 720 may perform a multiplication operation on the second parameter (x+1) and the output value of the subtractor 710. In cases where the subtractor 710 performs a subtraction operation on the first reference value (refMain1) and the second reference value (refMain2), the multiplier 720 may perform a multiplication operation on the third parameter and the output value of the subtractor 710.

The shifter 730 may shift the first reference value (T or L or refMain1) by N bits. As described above, this essentially corresponds to a multiplication operation on the first reference value (T or L or refMain1) and a predetermined constant (sN or 32) expressed as 2^{N}.

The first adder 740 may perform an addition operation on a product of the first reference value (T or L or refMain1) multiplied by a predetermined constant (sN or 32) and the output value of the multiplier 720, and the output value of the first adder 740 may be inputted to the selector 750. Then, the selector 750 may output the output value of the first adder 740 through any one of a first path, a second path, and a third path.

Here, the first path may be connected with the storer 760, and the second path may be connected with the second adder 742. Also, the second adder 742 may be connected with the output end of the storer 760, and the output value of the second adder 742 may correspond to the resultant value of the intra prediction for the image according to the planar mode.

Also, the third path may be directly connected with the output end of the planar/angular-mode intra prediction device 700, and the output value of the first adder 740 outputted through the third path may correspond to the resultant value of the intra prediction for the image according to an angular mode.

The planar/angular-mode intra prediction device 700 having the composition above may perform a planar-mode intra prediction operation, as described with reference to FIG. 5, during the first time segment and the second time segment, and may perform an angular-mode intra prediction operation, as described with reference to FIG. 6, during a third time segment. Here, the third time segment may be a time segment unrelated to the first time segment and second time segment, with no ordinal relationship therebetween. Also, the first time segment can be a time segment that comes before or after the second time segment.

More specifically, when the planar/angular-mode intra prediction device 700 performs the planar-mode intra prediction, the selector 750 may output the output value of the first adder 740 through either of the first path and the second path during the first time segment and second time segment, and other operations may be the same as those of the planar-mode intra prediction device 500 described above with reference to FIG. 5. Thus, redundant descriptions are omitted.

Also, when the planar/angular-mode intra prediction device 700 performs the angular-mode intra prediction, the selector 750 may output the output value of the first adder 740 through the third path during the third time segment, and other operations may be the same as those of the angular-mode intra prediction device 600 described above with reference to FIG. 6. Thus, redundant descriptions are omitted.

As set forth above, a planar/angular-mode intra prediction device 700 based on this embodiment can perform the same operations even with one less subtractor, multiplier, adder, and shifter, compared to the case of manufacturing the planar-mode intra prediction device 500 and the angular-mode intra prediction device 600 separately, so that the size of the hardware can be reduced even further.

While the present invention has been described above using particular examples, including specific components, by way of limited embodiments and drawings, it is to be appreciated that these are provided merely to aid the overall understanding of the present invention, the present invention is not to be limited to the embodiments above, and various modifications and alterations can be made from the disclosures above by a person having ordinary skill in the technical field to which the present invention pertains. Therefore, the spirit of the present invention must not be limited to the embodiments described herein, and the scope of the present invention must be regarded as encompassing not only the claims set forth below, but also their equivalents and variations.

1. An intra prediction device for intra prediction of an image, the intra prediction device comprising:
a subtractor configured to perform a subtraction operation on a first reference value and a second reference value of a prediction target pixel;
a multiplier configured to perform a multiplication operation on a parameter set for each angular mode and an output value of the subtractor; and
an adder configured to perform an addition operation on a product of the first reference value multiplied by a predetermined constant and an output value of the multiplier,
wherein an output value of the adder is a resultant value of intra prediction for the image according to an angular mode.

2. The intra prediction device of claim 1, further comprising:
a shifter configured to perform a multiplication operation on the first reference value and the predetermined constant,
wherein the predetermined constant has a value of 2^{N} (N is a predetermined integer), and the shifter shifts the first reference value by N bits.

3. The intra prediction device of claim 1, wherein the resultant value of intra prediction for the image according to the angular mode is expressed by an equation shown below:
outputₐ=(32−Delta)×refMain1+Delta×refMain2
where outputₐ is the resultant value of intra prediction for the image according to the angular mode, 32 (=2^{N}, where N=5) is the predetermined constant, Delta is the parameter, refMain1 is the first reference value, and refMain2 is the second reference value.

4. An intra prediction device for intra prediction of an image, the intra prediction device comprising:
a subtractor configured to perform a subtraction operation on a first reference value and a second reference value of a prediction target pixel;
a multiplier configured to perform a multiplication operation on a parameter associated with a position of the prediction target within an intra prediction block and an output value of the subtractor;
a first adder configured to perform an addition operation on a product of the first reference value multiplied by a predetermined constant and an output value of the multiplier; and
a second adder configured to perform an addition operation on an output value of the first adder at a first timepoint and an output value of the first adder at a second timepoint,
wherein an output value of the second adder is a resultant value of intra prediction for the image according to a planar mode.

5. The intra prediction device of claim 4, further comprising:
a selector configured to output the output value of the first adder through either one of a first path and a second path; and
a storer connected to the first path and configured to store the output value of the first adder,
wherein the second path is connected to the second adder, and the second adder performs the addition operation on the output value of the first adder stored in the storer and the output value of the first adder outputted through the second path.

6. The intra prediction device of claim 4, further comprising:
a shifter configured to perform a multiplication operation on the first reference value and the predetermined constant,
wherein the predetermined constant has a value of 2^{N} (N is a predetermined integer), and the shifter shifts the first reference value by N bits.

7. The intra prediction device of claim 4, wherein the first reference value includes a 1-1 reference value, the second reference value includes a 2-1 reference value, and the parameter includes a first parameter associated with a vertical-axis position of the prediction target pixel within the intra prediction block, and
within a first time segment including the first timepoint, the subtractor performs a subtraction operation on the 1-1 reference value and the 2-1 reference value, the multiplier performs a multiplication operation on an output value of the subtractor and the first parameter, and the first adder performs an addition operation on a product of the 1-1 reference value multiplied by the predetermined constant and an output value of the multiplier to provide an output at the first timepoint.

8. The intra prediction device of claim 4, wherein the first reference value further includes a 1-2 reference value, the second reference value further includes a 2-2 reference value, and the parameter further includes a second parameter associated with a horizontal-axis position of the prediction target pixel within the intra prediction block, and
within a second time segment including the second timepoint, the subtractor performs a subtraction operation on the 1-2 reference value and the 2-2 reference value, the multiplier performs a multiplication operation on an output value of the subtractor and the second parameter, the first adder performs an addition operation on a product of the 1-2 reference value multiplied by the predetermined constant and an output value of the multiplier to provide an output at the second timepoint.

9. The intra prediction device of claim 8, wherein the resultant value of intra prediction for the image according to the planar mode is expressed by an equation shown below:
outputₚ=(nS−(x+1))×L+(x+1)×Lr+(nS−(y+1))×T+(y+1)×Tr
where outputₚ is the resultant value of intra prediction for the image according to the planar mode, nS(=2^{N}, where N is a predetermined integer) is the predetermined constant and is a number of pixels corresponding to a horizontal/vertical length of the intra prediction block, x is a horizontal-axis position of the prediction target pixel, x+1 is the first parameter, L is the 1-1 reference value, Lr is the 2-1 reference value, y is a vertical-axis position of the prediction target pixel, y+1 is the second parameter, T is the 1-2 reference value, and Tr is the 2-2 reference value.

10. An intra prediction device for intra prediction of an image, the intra prediction device comprising:
a subtractor configured to perform a subtraction operation on a first reference value and a second reference value of a prediction target pixel;
a multiplier configured to perform a multiplication operation on a predetermined parameter and an output value of the subtractor;
a first adder configured to perform an addition operation on a product of the first reference value multiplied by a predetermined constant and an output value of the multiplier; and
a second adder configured to perform an addition operation on an output value of the first adder at a first timepoint and an output value of the first adder at a second timepoint,
wherein an output value of the second adder is a resultant value of intra prediction for the image according to a planar mode, and an output value of the first adder at a third timepoint is a resultant value of intra prediction for the image according to an angular mode.

11. The intra prediction device of claim 10, further comprising:
a shifter configured to perform a multiplication operation on the first reference value and the predetermined constant,
wherein the predetermined constant has a value of 2^{N} (N is a predetermined integer), and the shifter shifts the first reference value by N bits.

12. The intra prediction device of claim 10, further comprising:
a selector configured to output the output value of the first adder through any one of a first path, a second path, and a third path; and
a storer connected to the first path and configured to store the output value of the first adder at the first timepoint,
wherein the second path is connected to the second adder, and the second adder performs the addition operation on the output value of the first adder stored in the storer and the output value of the first adder outputted through the second path at the second timepoint, and
the output value of the first adder at the third timepoint is outputted through the third path.

13. The intra prediction device of claim 12, wherein, in cases where the intra prediction device performs the intra prediction of the image according to the planar mode,
the first reference value includes a 1-1 reference value and a 1-2 reference value, the second reference value includes a 2-1 reference value and a 2-2 reference value,
the predetermined parameter includes a first parameter associated with a vertical-axis position of the prediction target pixel within the intra prediction block and a second parameter associated with a horizontal-axis position of the prediction target pixel, and
the selector outputs the output value of the first adder through either one of the first path and the second path.

14. The intra prediction device of claim 13, wherein, within a first time segment, the subtractor performs a subtraction operation on the 1-1 reference value and the 2-1 reference value, the multiplier performs a multiplication operation on an output value of the subtractor and the first parameter, the first adder performs an addition operation on a product of the 1-1 reference value multiplied by the predetermined constant and an output value of the multiplier, and the selector outputs the output value of the multiplier through the first path.

15. The intra prediction device of claim 13, wherein, within a second time segment, the subtractor performs a subtraction operation on the 1-2 reference value and the 2-2 reference value, the multiplier performs a multiplication operation on an output value of the subtractor and the second parameter, the first adder performs an addition operation on a product of the 1-2 reference value multiplied by the predetermined constant and an output value of the multiplier, and the selector outputs the output value of the multiplier through the second path.

16. The intra prediction device of claim 10, wherein, in cases where the intra prediction device performs the intra prediction of the image according to the angular mode,
the predetermined parameter is a third parameter set for each angular mode, and the selector outputs the output value of the first adder through the third path.
